(19) United States
(12) Patent Application Publication
(10) Pub. No.: US 2019/0343056 A1
(43) Pub. Date: Nov. 14, 2019

(54) ROTARY GARDEN APPARATUS, METHOD AND SYSTEM

(71) Applicant: Paul William Brown, Barrie (CA)

(72) Inventor: Paul William Brown, Barrie (CA)

(21) Appl. No.: 16/406,952

(22) Filed: May 8, 2019

Related U.S. Application Data
(60) Provisional application No. 62/668,417, filed on May 8, 2018.
(60) Provisional application No. 62/779,645, filed on Dec. 14, 2018.

(51) Int. Cl. A01G 31/04; A01G 7/04; A01G 31/06; A01G 27/00; A01G 9/02; A01G 9/24

(52) U.S. Cl. CPC A01G 31/047; A01G 7/045; A01G 31/06; A01G 9/249; A01G 27/001; A01G 9/027; A01G 27/008

(57) ABSTRACT

A rotary garden apparatus, method and system for growing plants comprising an open rotatable cylindrical drum mounted within a structural frame is provided wherein said apparatus comprises an accessible front area permitting access to the drum and grow trays mounted on said drum from the front of the apparatus. The rotating drum portion comprises metal bars which form struts round the periphery of the drum on which grow trays can be mounted. The grow trays are inserted by sliding them along the struts of the drum and they are held in position by arms which extend below the metal struts over which the grow trays slide into position. The inverted T shaped fit between the tray and the strut holds the tray in position during rotation without further securing mechanisms required. The operation and most routine maintenance of the apparatus can all be done from the front of the apparatus thereby permitting multiple apparatus units to be placed side by side in a grow facility or against walls. The apparatus may be stacked one above the other all of which maximizes the number of units which can be present in a defined floor space in a grow facility. A light source comprising a holding tray, a sleeve and at least one bulb as part of a rotary garden apparatus is present in the rotary garden apparatus providing light for growing plants.

### TECHNICAL FIELD

The embodiments described herein relate to an apparatus, system and methods for a rotary garden grow apparatus, system and methods for growing plants. More specifically they relate to an apparatus for rotary gardening that facilitates the growth of multiple plants on a commercial scale and to related systems and methods. The embodiments further relate to accessories including a removable growing tray for use in a rotary garden apparatus and related systems and methods for use of the removable tray in the growing system. The removable growing tray has a removable cover which in one embodiment is in the nature of a gasket that mounts on top of the growing tray. The embodiments described herein also relate to a grow light for plants grown in a rotary garden grow apparatus.

### BACKGROUND

The use of indoor commercial gardening systems is an effective method for growing plants on a commercial scale. The growth of a large number of plants per unit area of a growing facility is maximized when more plants can be grown in a defined area. Furthermore, the use of indoor commercial gardening apparatus, methods and systems allows for greater control of growing conditions. Standardized or controlled growing conditions can contribute to faster plant growth and healthier plants.

Given that indoor growing facilities can be costly, space saving systems help maximize the quantity of plants grown in an indoor grow facility. Rotating gardening systems are described, for example, in U.S. Pat. No. 7,181,886 (Bourgoin et al.) and U.S. Pat. No. 7,730,663 (Souvlos et al.) and U.S. Patent Application No. 14/883,156 (Gallant).

Existing gardening systems often require access to trays or components from many sides of the apparatus thereby preventing the rotary garden units from being placed side-by-side or against a wall without leaving space around the apparatus. There is a need for rotary gardening apparatus, methods and systems which are primarily accessed from one end. Front access allows two or more units to be placed closely side-by-side without space between or against or beside a wall, thereby conserving floor space and allowing more units to be placed in a grow facility.

Any reference herein to known prior art does not, unless the contrary indication appears, constitute an admission that such prior art is commonly known by those skilled in the art to which the invention relates, at the priority date of this application.

### SUMMARY

A rotary garden apparatus is disclosed which, when in use, is accessed from the front during routine use and is constructed to permit linear side-by-side arrangements with little or no space between each unit. In addition to conserving valuable grow space, less time is needed to manage the grow systems since the apparatus does not need to be moved and can remain in one position. Units may be mounted on wheels in one embodiment so they can be pulled out for maintenance and repair. In routine day to day use the rotary garden apparatus can abut a wall at the rear without need to be moved during the input and removal of the plants. Grow trays can be withdrawn from the front and filled with new plants or grown plants can be removed.

Grow tray embodiments are taught as part of the rotary apparatus and related systems and methods and also related accessories for the apparatus. In a preferred embodiment grow trays which are slidably positioned in place are taught which may or may not have covers. In a preferred embodiment the cover is in the nature of a gasket which covers the grow tray and comprises openings through which plants can grow. The cover is attachable to the tray and may be permanently attached or removably attached. The cover for a grow tray in some embodiments is considered a separate part or accessory which is sold separately. In other embodiments it may be attached to the grow tray and liftable for plants to be placed in the growing medium of the tray.

In preferred embodiments, the growing trays are mounted along the periphery of a drum which is mounted in a metal frame structure and the frame is substantially rectangular or substantially square in shape. It is recognized that modifications to ellipses, ovals, or other shapes for the frame would also work. It is recognized that the frame need not be restricted to metal; however, a strong frame material is required to withhold the weight of the drum when all the trays are in place containing a full quote of plants. Rectangular or square shapes are preferred in grow rooms as the shapes are more efficient for placing close beside one another or a wall. Advantageously even when placed close to a wall or one another the trays can be removed from the drums without need to move the apparatus thereby allowing a configuration that is most efficient for large growing operations.

Growing trays in some embodiments have improved drainage and water distribution features in an automated rotary gardening apparatus and system including but not limited to one or a plurality of side or end or other openings in the growing trays.

There is provided a rotary garden apparatus for growing plants comprising an open rotatable drum mounted within a structural frame the apparatus comprising an apparatus front end and an apparatus back end, the drum comprising two drum support rings between which a plurality of mounting struts are extended and connected to each drum support ring; the drum further comprising radial support arms attached at a back end of the apparatus extending across a diameter of the drum support ring at the drum back end; the mounting struts comprising a protuberance the protuberance comprising arm portions and the protuberance extending along the mounting strut; the drum further comprising a substantially open drum front end; the substantially open drum front end further comprising an accessible area through the opening is unobstructed by the structural frame; the apparatus further comprising a main gear mounted to the apparatus back end; the apparatus further comprising a feed tray mounted to the structural framework and positioned below the drum; the apparatus further comprising a lower reservoir positioned below the feed tray and the lower reservoir is optionally connected to the frame; wherein the drum rotates within the structural framework passing through the feed tray. The drum support rings can be made of metal or any appropriate material such as a polymer or composite material. The mounting struts can be made of metal or any appropriate material such as a polymer or composite material.

In one embodiment there is provided a removable growing tray for a rotary garden apparatus, the tray being shaped so as to be slidably receivable by supports or struts of a rotary garden apparatus.

In another embodiment the growing trays can be substantially the same length as supports or struts of a rotary garden apparatus.

In another embodiment some but not all of the growing trays are substantially the same length at supports or struts of a rotary garden apparatus.

In another embodiment a rotary garden apparatus is provided with growing trays of different lengths.

In another embodiment growing trays can include at least one groove, furrow, trench or dimple shaped to receive a corresponding protuberance or projection on supports or struts or other mounting means of a rotary garden apparatus.

In another embodiment growing trays can include a projection or protuberance to be received within a corresponding furrow, groove, trench, or dimple on supports, struts or other mounting means of a rotary garden apparatus.

In another embodiment the at least one groove, furrow, trench or dimple can be shaped to cooperatively engage the protuberance or projection to allow the two to engage together or to slidably engage together.

In another embodiment at least ogle groove can have a T-shape cross section.

In another embodiment said protuberance or projection is a T-shape in cross section.

In another embodiment the trays can be substantially square or rectangular in cross section.

In another embodiment the at least one groove, furrow, trench or dimple can be on a one side of the tray and an open slot is present along an opposite side of the tray and the open slot can be adapted to be directed towards the interior of a rotary garden apparatus when mounted thereon.

In a preferred embodiment plants growing in said tray grow through the open slot and are illuminated by light means located on the interior of the rotary garden apparatus.

The growing tray can further include a cover or gasket to close the open slot completely or partially or intermittently.

In another embodiment the cover or gasket includes at least one opening or open portion which aligns with the open slot on the growing tray, in a preferred embodiment.

In accordance with a preferred embodiment the cover or gasket can be impermeable water, and can be manufactured of rubber or other polymeric material, in preferred embodiments.

in accordance with another embodiment a growing tray can further comprise at least one side opening on at least one side of the tray.

In accordance with another embodiment, the at least one side opening can range in size from about 1.8 cm to about 2.8 cm in dimension in a preferred embodiment.

In accordance with another embodiment, a growing tray can have at least one hydroponic substrate present inside the tray when in use in a rotary garden apparatus or when not in use in a rotary garden apparatus.

In accordance with another embodiment plants, buds, or seeds can be present in at least one hydroponic substrate in a growing tray.

In accordance with another embodiment, plants can grow through an open slot or opening in the growing tray. In accordance with another embodiment, plants can grow through the at least one opening in the cover or gasket which is aligned with the position of the plant in the growing tray.

In accordance with another embodiment there is provided a growing tray cover for closing an opening of a growing tray, the cover having a central portion, and at least one side portion which is adapted to engage at least one formation on a growing tray so that a cover and a growing tray can be assembled together. In accordance with another embodiment the growing tray and the cover are assembled after hydroponic substrate and/or plants, buds or seeds, are present in the growing tray.

In accordance with one embodiment a growing tray cover comprises at least one side portion in one embodiment, and preferably includes two side portions.

In accordance with one embodiment, the at least one side portion may further comprise or alternatively comprise a beveled portion.

In accordance with another aspect, if two side portions are present then the respective beveled sections are oppositely directed so that the base of the cover is wider than the top.

In accordance with another aspect a central portion of a grow tray cover comprises at least one aperture therethrough to allow a plant to grow through.

In accordance with another aspect a central portion of a cover for a grow tray can include a channel section, which can also include the at least one aperture.

In accordance with another aspect a cover for a grow tray is a gasket or in the nature of a gasket covering a side opening in a growing tray to retain moisture in the tray and further comprising one or more openings through which plants rooted in a hydroponic substrate in the growing tray, may grow through.

### BRIEF DESCRIPTION OF THE FIGURES

The detailed description is described with reference to the accompanying Figures. The use of the same reference number in different figures indicates similar or identical elements. Other and further advantages and features will be apparent to those skilled in the art from the following detailed description when taken together with the accompanying Figures.

For the purpose of illustration, there is shown in the Figures exemplary embodiments exemplifying the embodiments as taught in the detailed description. It is understood that the scope of the present invention as encompassed by the claims and presented in the description, is not limited to the precise arrangements, instrumentalities, or exact depictions shown or illustrated in the Figures. Other embodiments would be understood to persons skilled in the art, having the benefit of this specification, to be operable within the scope of the appended claims.

In the accompanying Figures like reference numerals refer to like or similar parts, in which:

FIG. 1 is a front and side perspective view of an embodiment of a rotary garden apparatus.

FIG. 2 is an alternate front and top perspective view of a rotary garden apparatus.

FIG. 3 is a rear and side perspective view of a rotary garden apparatus.

FIG. 4 is an enlarged view of FIG. 3 illustrating a main gear positioned at the rear of a rotary garden apparatus.

FIG. 5 is a left side view of a rotary garden apparatus.

FIG. 6 is a front view of a rotary garden apparatus.

FIG. 7 is a right side view of a rotary garden apparatus.

FIG. 8 is a rear view of a rotary garden apparatus.

FIG. 9 is a top view of a rotary garden apparatus.

FIG. 10 is a bottom view of a rotary garden apparatus.

FIG. 11 is a front perspective view of one embodiment of a growing tray for use in a rotary garden apparatus.

FIG. 12 is a rear perspective view of the growing tray of FIG. 11.

FIG. 13 is a side view of the growing tray of FIG. 11.

FIG. 14 is an enlarged view of the portion of the growing tray within the dot-line box of FIG. 13.

FIG. 15 is a front view of the growing tray of FIG. 11.

FIG. 16 is a top view of the growing tray of FIG. 11.

FIG. 17 is a bottom view of the growing tray of FIG. 11.

FIG. 18 is a front perspective view of a growing tray with a gasket in place over the top of the growing tray.

FIG. 19 is an enlarged view of a side of the growing tray of FIG. 18 and is a similar view as FIG. 14 but now presented with a gasket in place.

FIG. 20 is a front view of the growing tray of FIG. 18 illustrating a gasket in place.

FIG. 21 is an enlarged view of a portion of a rotary garden apparatus showing the growing tray as it is positioned on a drum of the rotary garden apparatus.

FIG. 22 is a front and side perspective view of a rotary garden apparatus illustrating a control box and fans in dot-chain.

FIG. 23 is a front and side perspective view of a vertically stacked configuration of a rotary garden apparatus with two units stacked one above the other.

FIG. 24 illustrates a section of a growing tray with a hydroponic substrate, plants and a gasket in place on the growing tray.

FIG. 25 illustrates a light fixture within the drum depicting an embodiment with 4 bulbs.

FIG. 26 illustrates an interior embodiment of a rotary garden apparatus inside a drum of the rotary garden apparatus looking towards the rear of the apparatus depicting a light fixture with four bulbs and 5 radial support arms.

FIG. 27 illustrates an underneath perspective of the cover 210 of earlier figures.

FIG. 28 illustrates an upper perspective view of the cover 210 of FIG. 27.

### DETAILED DESCRIPTION

The rotary garden apparatus, accessories, methods and systems comprise various embodiments defined within the scope of the appended claims. Embodiments of the rotary garden apparatus, accessories, methods and systems are described. Other embodiments would be understood to persons skilled in the art, having the benefit of this specification, to be operable within the scope of the appended claims.

The apparatus comprises a free standing framed structure for growing large numbers of plants at the same time. Growing trays are arranged around the circumference or periphery of a central rotating drum mounted on the frame. The growing trays are removable from the front of the rotary garden unit and, in a preferred embodiment, are reusable.

Since the trays and other accessories including light fixtures and light bulbs are replaced from the front of the apparatus a unit can be placed so the rear side is close to a wall or to the back of a second similar device in a back to back arrangement. In addition, one apparatus may be stacked above a second apparatus. The arrangement permits each apparatus to be arranged in multiple groupings without having to leave space between one unit and the next when lined up beside one another so long as the front of each apparatus is accessible to permit insertion and removal of the growing trays and other accessories.

The arrangement of the units side by side, back to back, or against a wall beneficially permits an increased number of units, and therefore plants, per square foot of floor space as compared to systems accessed from the side for example. Commercial growing of plants is facilitated by placement on the apparatus of access points and controls at the front of the unit since routine access to the back or rear of the apparatus is not required for day to day use of the rotary garden apparatus. Access to the back is possible for repair or maintenance on an as needed basis; however, the routine daily activities surrounding the replaceable and reusable accessories and parts for plant growth may be completed by accessing the front of the apparatus only.

This allows the apparatus to be backed against a wall and one apparatus can be placed directly beside the next without much space between each apparatus. A central aisle between rows permits the necessary access to each rotary garden apparatus (each unit) from the front. These various configurations larger configurations or arrangements of units within a growing facility.

Each apparatus comprises a plurality of grow trays which are removably mountable on the drum. The trays rotate as the drum turns at a rate of rotation determined by the user suitable to keep the plants fed and watered during the growing period for each plant or plant cycle.

Feeding and watering of the plants is automated. In one embodiment a water and nutrient solution feed tray is placed under the drum. As the apparatus rotates around a central axis each tray of plants dips into and passes through a nutrient solution in the feed tray and receives nutrients and water if present in the feed tray. In one embodiment the drum rotates continuously but the feed tray may be filled or drained at various times.

Each rotary garden apparatus, when in use, rotates at a rotational speed that is determined to be optimal for the type of plant and the number of plants growing in the unit. The duration for one rotation of the device in turn controls how long a tray of plants is exposed to the nutrient solution in the feed tray assuming the apparatus is rotating at a constant speed. The programming of the rotational speed can control the length of time a row of plants is exposed to the nutrient feeding solution and is changeable if needed depending on, for example, plant type and nutrient solution composition and/or concentration. In other embodiments the rate of rotation is programmed to be either a fixed rate or a variable rate and may be controlled by buttons in a control unit.

Each apparatus comprises a plurality of placements for growing trays which will hold the plants in position during the plant growing time in the rotary garden apparatus. The growing trays are linear. An opening extends along the top of the growing tray through which the plants grow. The opening may be continuous or discontinuous. The growing trays are filled with a suitable hydroponic substrate and one or more plants are placed, spaced apart, in the substrate.

In a preferred embodiment a suitable hydroponic substrate is a rockwool cube in which the plant growth may have been previously commenced; however, one skilled in the art would appreciate that other hydroponic substrates would also work. Rockwool or stonewool is made from rock that has been melted and spun into fibrous cubes or growing slabs for use as hydroponic substrate in hydroponic growing systems. Rockwool provides roots with a foundation in which to grow and receive nourishment hydroponically. Rockwool is one preferred embodiment which provides roots with a supportive growing environment together with good balance of water and oxygen retained in the substrate from which the plant roots will draw the necessary water and nutrients for growth. Rockwool cube hydroponic substrates are preferred for use in the rotary garden apparatus but others as described would also work. The composition of a suitable substrate permits the cube or growing slab to be saturated with water or other nutrient solution, retain the solution in the rockwool cube fibrous network while permitting excess solution to drain away providing retained moisture to feed the plant by way of the roots which are contained in the substrate.

One skilled in the art would appreciate that there are many other suitable hydroponic substrates which could be used in the present invention as described. In a preferred embodiment the substrate is formed to fit the interior holding space of the grow tray. In a preferred embodiment there are multiple substrate cubes which can be slid or pushed into the tray forming a line along the length of the linear grow tray. The size of the trays can vary with the size of the device; however, it is appreciated that trays may be different lengths and more than one tray may be present in a given slot.

Alternative hydroponic substrates are known in the art and suitable choices would be known to one skilled in the art including without limitation perlite, vermiculite, expanded clay pellets, hydroton clay, polished stones of suitable size, sand, gravel, sawdust, lava rock, absorbing polymer crystals, oasis cubes, Growstone™ hydroponic substrate and rice hulls in addition rockwool and stonewool. The hydroponic substrate is formed into a suitable growing cube or growing slab which is fitted into a growing tray of the rotary garden apparatus.

In a preferred embodiment rockwool cubes are used for as a suitable hydroponic substrate in which the plants grow. The rockwool cube can slide into the growing tray, be pushed along the length of the growing tray or placed inside at appropriate intervals. The plants may be seeded into the rockwool cube either before or after the cube is placed in the growing tray. Alternatively, the plants have begun to grow the cube is placed into the growing tray.

A plurality of rockwool cubes may be fit into a tray by sliding or pushing the cubes into the tray until they completely or partially fill the tray. Depending on the purpose of the plant and how the plant grows the cubes can be spaced apart within the growing tray or pushed close to one another. To maximize the number of cubes per tray the rockwool cubes would be pushed together until the tray is full. In a preferred embodiment each growing tray can accept up to about one dozen cubes when completely filled but shorter or longer lengths are possible.

Each rockwool cube, or other suitable hydroponic substrate unit, contains one or more plants. The rockwool cube substrate or other suitable hydroponic substrate containing the one or more plants expands when exposed to fluids such as a water and/ or a nutrient solution thereby absorbing the fluid into the substrate and retaining the fluid in the substrate from which the plant will grow. The plant roots are contained within the substrate and the plant stem and leaves will grow out of the substrate through the opening in the tray.

As the rotary garden grow apparatus rotates the growing tray holding the rockwool cubes passes through the nutrient solution contained in the feed tray and then as the tray exits the nutrient solution in the feed tray the growing tray will tilt and excess nutrient solution from the hydroponic substrate will drip back into the nutrient solution in the feed tray where it can be reused by other plants passing through the nutrient solution as each tray rotates through the feed tray.

The tray in one embodiment is long and linear and made out of a solid material such as aluminum or a sturdy plastic or flexible plastic which is sufficiently lightweight to be handled and lifted by persons who load and unload the growing trays from the apparatus. In a preferred embodiment each tray holding the rockwool cubes or other hydroponic substrate containing the plants has one or more holes located along one or both sides of the growing tray. The additional hole or holes in sides of the tray permit nutrient solution to reach the middle of the tray and penetrate the rockwool cube or other suitable hydroponic substrate present in the middle of the growing tray more fully than if the solution must travel along the interior of the tray to reach the middle. One or more holes in one or more sides of the tray also enhance and render more effective drainage of excess solution. One or more holes in the side of a growing tray allows a nutrient solution to more evenly reach each of the plants growing in its own rockwool cube or hydroponic substrate along the length of the tray.

One or more holes located in one or more sides of the growing tray also permit more consistent drainage of excess water from the growing tray and from the substrate contained within the tray.

When a tray is fully loaded with the plants in the hydroponic substrate there will be some gaps between the rockwool cubes or other hydroponic substrate. Water and nutrient solution can also travel along these gaps but there may be unevenness with the plants located at the ends of the tray being exposed more fully to the water and nutrient solution than the plants position in the middle of the growing tray. Accordingly one or more holes in one or both sides of the tray permit improved distribution of the fluid solution(s) and the plants positioned in the middle of the tray are more likely to receive exposure to the water and nutrients more evenly along the length of the growing tray and plants in the middle of less likely to dry out while plants at the ends are still moist.

A distribution of at least one hole on at least one side of a growing tray permits the nutrient solution to more effectively nourish the plants in the rockwool cubes located in the central or middle portion of the tray. In a more preferred embodiment, a plurality of holes are spaced apart along the length of the tray spaced to be coincident or beside each plant substrate. In a preferred embodiment a linear arrangement of spaced openings are placed on one or both sides of the growing tray.

In the absence of the holes the plants located in hydroponic substrate in the centre or middle portion of a grow tray must rely on the nutrient solution transferring along the length of the tray from each end. In the preferred embodiment a series of openings are present in the side of the tray thereby permitting water or a nutrient solution to enter the tray at each of the rockwool cubes located along the tray length. Accordingly, a plurality of holes spaced apart along the length of the tray allow for a more balanced distribution of nutrient solution both entering the growing tray and exiting the growing tray.

During one rotation of the drum of the rotary garden apparatus a tray may be exposed to the nutrient solution in the feed tray for about 5 minutes although the timing can be adjusted based on the type of plant and the desired rotational speed by way of a control panel and electronics.

The openings in the side or sides of the tray allow for longer trays to be used thereby increasing the number of plants which can be contained in each tray; however, even with shorter trays (in a smaller scale apparatus) holes will assist with more even wetting and/or draining of the substrate. Each plant still receives sufficient nutrient solution for effective plant growth as well as release of excess water along the length of the tray. Mold growth or other spoilage of the plant by overwatering of the substrate is minimized by the improved drainage. Although holes in the side of the tray are not required for the plants to grow, they are a preferred embodiment for these reasons, for example. Shorter trays or longer trays may be used and the number of holes adjusted accordingly.

In one embodiment after the grow tray has been loaded with rockwool cubes containing the plants a cover with individual openings for each plant is placed over the gap in the top of the tray. In a preferred embodiment the cover is in the form of a gasket. In one embodiment the gasket is flexible and impermeable to light and water. In one embodiment the gasket is filled along the edges of the opening on the top of the growing tray. Holes are provided in the cover through which plants can grow. Stabilized in a hydroponic substrate, the plants grow through the opening in the grow tray and through a hole in the cover. To minimize moisture loss through the opening the gasket is fitted over the opening still permitting the growing plants to be exposed to light and fluids through the holes.

In another embodiment the tray is molded so the top is solid and openings have been provided for plants to grow through.

In a preferred embodiment a shaped flexible strip in the nature of a gasket for example covers the entire length of the opening along the top of the tray through which the plants grow. The flexible gasket is mounted on the edges of the growing tray. The edges are turned in one embodiment and the gasket is removably fitted over the turned edges. Holes in the gasket are positioned so plants can grow through the gasket holes. The gasket cover assists in moisture retention within the hydroponic substrate contained in the growing tray. The gasket also has a benefit of preventing dripping from the growing tray while it is rotating. Another benefit is light is restricted from getting to the roots of the plant.

A cover such as the preferred flexible gasket which is placed along the opening in the top of the tray provides an additional benefit of reducing the amount of light penetration onto the hydroponic substrate such as the rockwool cube and helps to prevent drying. The plant is exposed to the light as it extends beyond the gasket but the hydroponic substrate does not get the same amount of light exposure as it is protected by the cover. This reduces the exposure of the hydroponic substrate and plant roots therein to light thereby reducing the detrimental effects of light on the substrate and/or plant roots such as growth of algae.

In a preferred embodiment the length of the growing tray cover is matched to the length of the growing tray in a single flexible rubber strip and a hole is placed in the cover to align with each rockwool cube contained in the growing tray. The plants are positioned in the tray so when the gasket is placed over top the plants can extend through the holes in the cover. The gasket may also help reduce shifting of the substrate in the growing tray as the drum rotates.

The frame is made of a strong material such as powder coated steel and provides a solid structure on which the drum is rotatably mounted to or within the frame. The drum is located approximately in the middle of the frame and does not extend beyond the sides of the frame in a preferred embodiment. Attached to a main gear at the rear of the structural frame the drum rotates as the main gear turns. The gear is located at one end of the apparatus and radial support bars extend from the gear connecting the gear to a metal ring at the end of the drum. In a preferred embodiment the radial support arms of the drum are located at the rear of the drum and the main gear is located in a preferred embodiment centrally close to the radial support arms of the drum. In a preferred embodiment the main gear is mounted on the interior of the frame.

The other end of the drum has no support bars and is open to allow the plant growing trays to be inserted along the circumference of the drum. The opening may be fully open or partially open so long as the opening permits the user to insert the tray in and out of the drum on which it is mounted. The space required in front of the apparatus to permit insertion and removal of the tray will depend on the length of the trays. In some embodiments there may be two or more shorter trays which abut in the same slot or one longer tray.

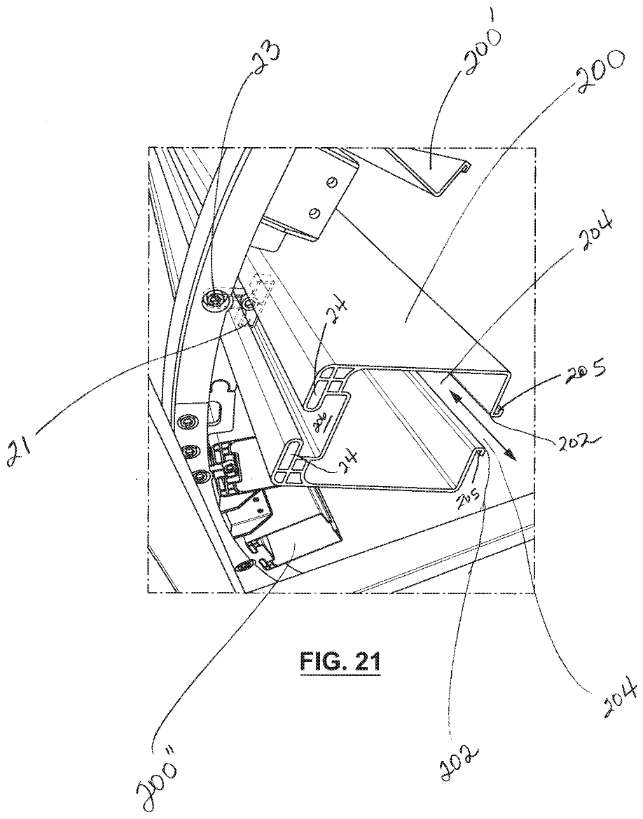

The drum comprises two metal rings, one at each end, which are connected by metal bars called struts or bars or tray mounting struts or tray mounting bars. The struts are shaped to receive the plant growing trays. The trays are shaped to be inserted into or removed from the struts by sliding. A preferred embodiment is illustrated in FIG. 21. In a preferred embodiment, the struts comprise a downward extending inverted T shaped portion along which the insertion and removal of the tray occurs. The base of the tray is configured to also have a T shaped opening that reciprocally matches the shape of the inverted T shaped portion on the strut. In this configuration a grow tray can slide into and be removed from a mounting strut for the tray. Each strut accommodates one tray in a preferred embodiment. The trays slide in and out of the apparatus along the struts. The metal inverted T shape portion is a protuberance which forms part of the strut in a preferred embodiment supports the when the tray is mounted on the strut. Two or more trays, if shorter, can be placed in one strut or bar.

A nutrient growing solution is pumped in and out of a lower reservoir which sits beneath the feed tray. The feed tray must be deep enough to receive the entire grow tray as it passes through the feed tray nutrient solution as the drum rotates. In a preferred embodiment the tray is fully submerged as it passes through the nutrient solution in the feed tray. One skilled in the art would appreciate that the tray must pass through the nutrient solution at a depth and for a time period that sufficiently wets the hydroponic substrate holding the plant.

With full or sufficient submersion of each tray as it rotates, the opportunity for the nutrient solution to enter through the ends of the tray and through the openings of the tray if openings are present, is maximized. As the tray completes its pass through the feed tray of nutrient solution the additional fluids will drip back into the tray therefore draining the substrate through the openings and holes.

While the drum rotates continuously the user can control when water and other nutrient solutions are present in the feed tray. The rate of pumping fluid can be controlled to fill the feed tray so that the plants will have sufficient water or other nutrient solution to wet the hydroponic substrate in which they are growing in the tray. If too much fluid enters into the feed tray an overflow valve permits the fluid to drain to avoid overflowing the feed tray. Once a full rotation of the device is completed the pump is turned off and any fluid remaining in the feed tray drains into the lower reservoir where it is kept until the next time the plants require watering and/or feeding.

The user can control how frequently the plants are watered or fed depending on the stage of growth of the plant.

When positioned on the strut of the drum the top of the tray points substantially inwardly towards the central open space of the drum with the plants extending towards the light fixture in a central open space in the centre of the drum. The tray stays in this position and does not swing when mounted on the mounting strut. It is the rotation of the drum which causes the tray to pass through the solution.

A light source is located centrally in the apparatus around which the drum rotates. In a preferred embodiment a light fixture is the light source and is positioned in about the middle of the central portion of the drum. The light fixture is secured to at least one end of the frame of the apparatus extending from the back of the drum through the middle of the drum to the front of the drum thereby providing light illumination to all the plants when in use. In a preferred embodiment the spacing between the light source and the trays which contain the plants is ranges from 18 inches to 24 inches.

The light source in a preferred embodiment is a series of bulbs contained within a glass tube or sleeve. The glass tube is an air tube and the bulbs lie within the tube on a holder. The number of bulbs can be varied depending on the type of bulb and the type of light required for growing the plants. In one embodiment the bulbs are double ended 600 W HPS bulbs. In another embodiment the bulbs may be ceramic metal halide bulbs. In another embodiment the bulbs may be LED bulbs. In an LED embodiment the bulb may be one long bulb. In other embodiments multiple bulbs may be used in the light source.

In a preferred embodiment four double ended 600 W HPS bulbs are positioned inside a glass tube. The bulbs are held in a holder that rests inside the tube. The holder has one or more power connections running from the light source to a control panel. The control panel is preferentially located on the front of the apparatus so it is readily accessible and the bulbs can be changed from the front of the unit. In one embodiment each bulb has its own power cord. The ballast for the bulbs is digital and the ballast is also located in the control panel on the front of the apparatus so it can be replaced without having to move the unit.

The light source is contained within a transparent enclosure or box. The light source can be accessed from the front of the apparatus through which a door opens into the enclosure. The bulbs can be removed or replaced through this access point. In a preferred embodiment the light source is a double-ended high pressure sodium bulb. In a preferred embodiment there are four bulbs.

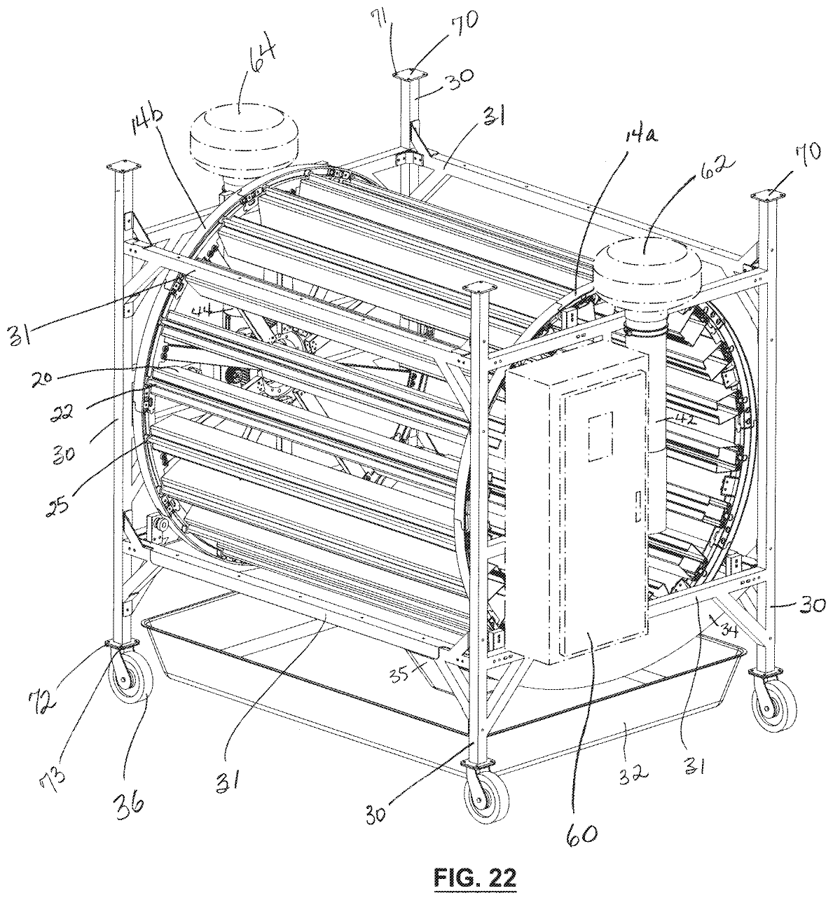

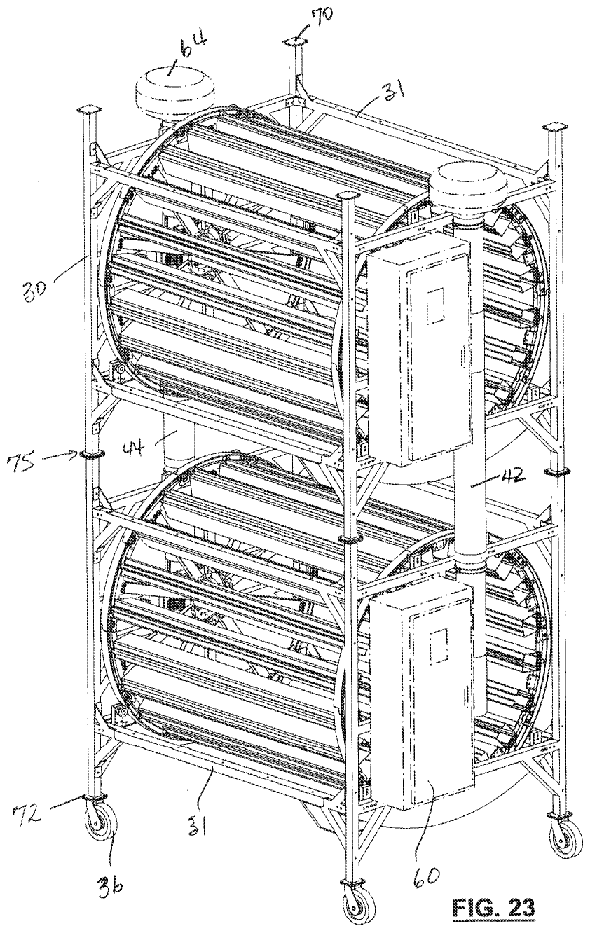

When in use, the light source will generate heat which should be dispersed. An example of a mechanism for dispersing heat from the light is to connect the glass air tube to an exhaust mechanism. An exhaust system located at the front and back of the apparatus provides ventilation inlet and outlet pipes permitting heat generated to flow away from the light source through the outlet pipe as one example of an exhaust mechanism. A fan connects to an inlet pipe in this example, which carries air towards the light source and an outlet pipe which carries air away from the light source. Separate fans may be mounted directly on the inlet and/or outlet pipes as illustrated in FIGS. 22 and 23. In another embodiment an exhaust system may be mounted in the ceiling above the unit and connected through piping or tubing to the inlet and outlet pipes mounted on the apparatus at either of the light enclosure.

A control box and power supply are connected to the apparatus and provide the power to the gear which turns the drum within the frame of the apparatus. The rate of rotation is controlled by the control box. The control box can also control the pumping of fluids from a lower reservoir into a feed tray.

In the embodiments depicted in the Figures the lower reservoir is a tray that rests on the floor beneath the apparatus with the feed tray positioned above. The pump is not shown. In the specific embodiment depicted the tray is approximately the same area as the area the apparatus occupies between the vertical legs when standing on the floor. The tray is sized so that it can be removed by pulling it out from under the apparatus and replaced with a new tray. For example, when the nutrient solution is no longer intended to be re-used and most be disposed. Fresh nutrient solution can fill a replacement tray. Alternatively, a centralized system of feeding is another option.

In the Figures embodiments of the rotary garden apparatus are further taught. Figure one illustrates one embodiment of a rotary garden growing apparatus from a front-side perspective view.

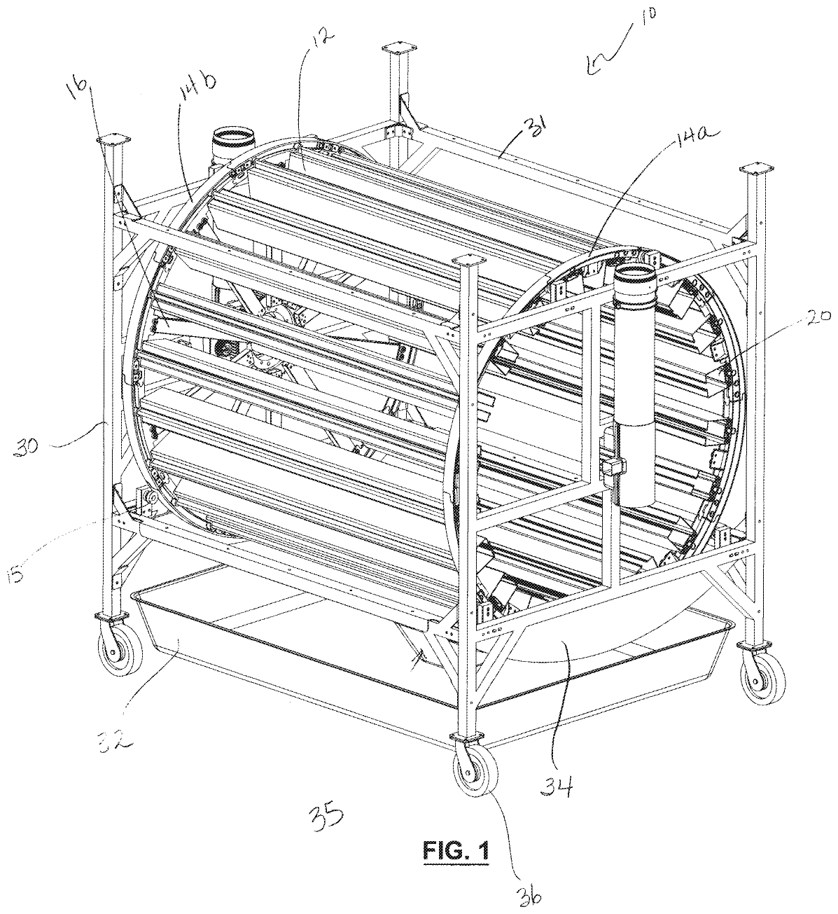

Turning to the Figures, in FIG. 1 a rotary garden growing apparatus 10 is illustrated. The apparatus comprises a metal structural framework made in one embodiment of powder coated steel or other suitable metal. The metal structural framework provides the frame components require to mount various working parts as well as a structure which can be moved and even stacked. Part of the structural framework comprises vertical supports frame components 30 and horizontal frame components 31. The apparatus 10 depicts one embodiment of a single unit of the apparatus but not all parts may be mounted in any one Figure even though as all may be present on the apparatus when in use.

The rotary growing garden growing apparatus 10 has a feed tray 34 located beneath drum 12 and above lower reservoir 32. In the feed tray 34 there is a molded part which has an overflow drain in it which comprises a valve or other suitable mechanism. Water and/or nutritional solutions for feeding and watering the plants are pumped into the feed tray from an external source outside of the apparatus per se. The water or other nutritional solutions is pumped in one embodiment from a separate holding tank located within the facility housing the apparatus which may work in connection with a supply line to each of the apparatus units housed in the facility.

A submersible water pump, not illustrated, located in or connected to the holding tank can pump the water or other solutions into the feed tray 34. It may be a manual, mechanical or electronic system or a combination. When the water or nutritional solutions reach a certain level in the feed tray 34 the overflow will drain through drain 35 back into the lower reservoir 32 or other reservoir.

A lower reservoir 32 is positioned under apparatus 10. In one embodiment the lower reservoir is free standing and is positioned beneath feed tray 34. In another embodiment, not illustrated, a lower reservoir is attached to the apparatus in a position below the feed tray. In another embodiment, not illustrated, a separate reservoir is provided in the form of a holding tank located in the same facility as the growing apparatus. In another embodiment, a single lower reservoir extends beneath two or more units. A lower reservoir houses the fluids for feeding, watering and nourishing the plants. It is a larger reservoir than the feed tray and fluids in the lower reservoir are pumped from the lower reservoir to the feed tray in one embodiment. Other mechanical methods for moving fluids from the lower reservoir to the upped reservoir may include manual transfers of fluids or pressurized systems.

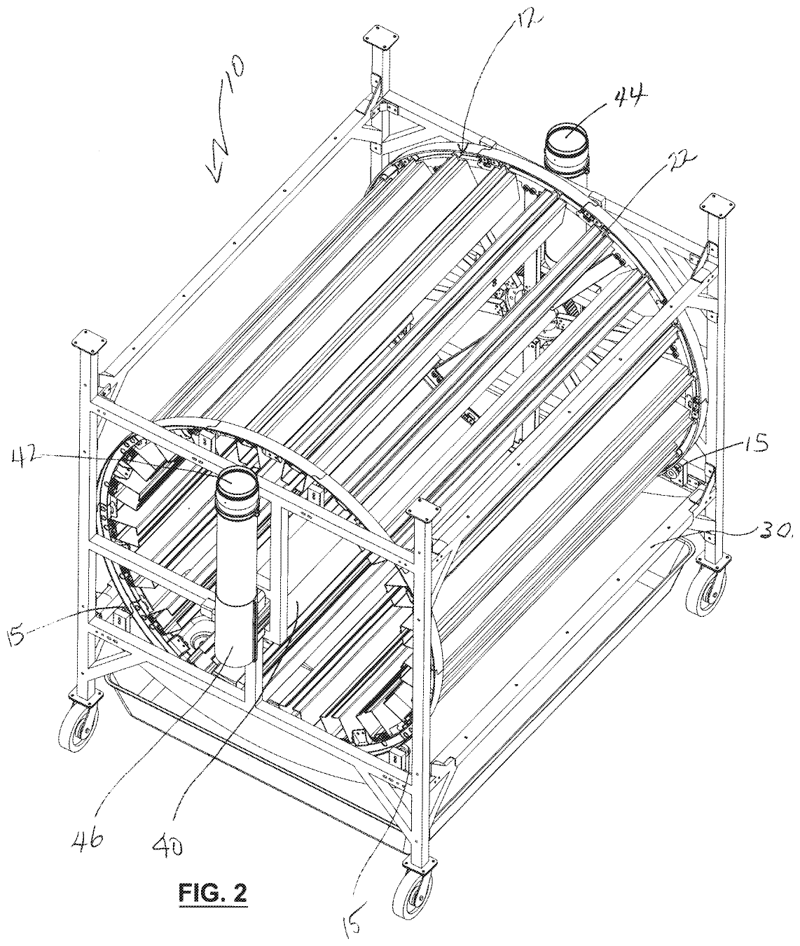

FIG. 2 illustrates an embodiment of a rotary garden growing apparatus from a front perspective view looking down on the top of the apparatus. In this view the drum 12 is mounted within the structural frame 13 on rollers 15 (three of the four rollers are visible in FIG. 2) which are located in each corner of the apparatus. The drum 12 rests on the roller in each corner in this embodiment. There may be a plurality of rollers in the corners and the rollers may be replaced by other similar devices on which the drum 12 may turn such as one or more gears.

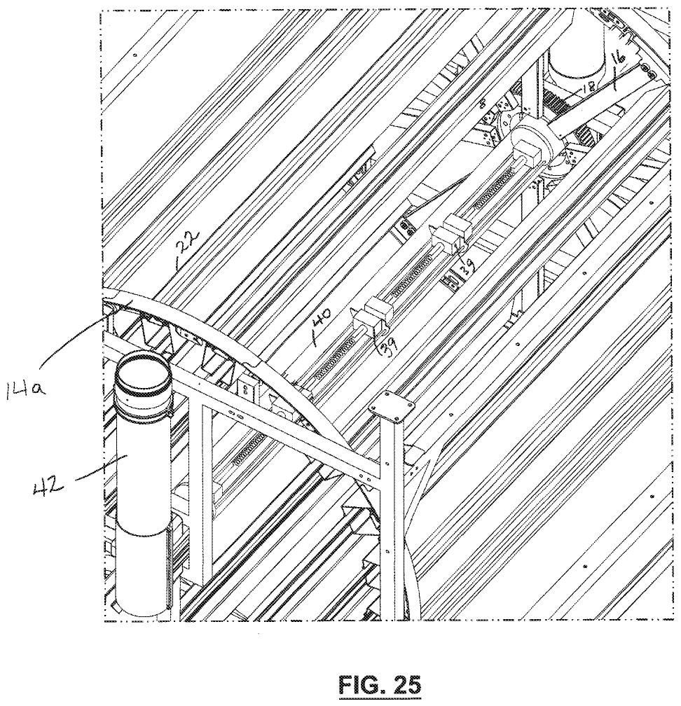

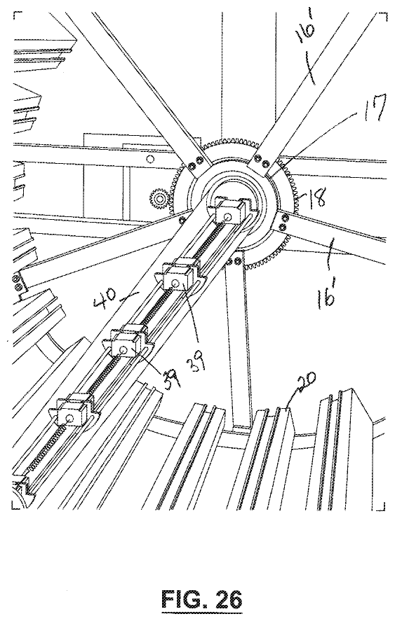

At either end of the apparatus inlet piping 42 and outlet piping 44 are located at the front and the back of the apparatus respectively. The piping provides airflow across and through the lighting means located in the centre of drum 12. The light fixture(s) or lamp(s) can be of various kinds all of which are suitable for providing the necessary light for plant growth. In FIG. 2 a sleeve protects and surrounds the light fixtures or lamps. The sleeve as illustrated in FIG. 2 houses light bulbs and a cover which are not illustrated in that Figure but can be seen, for example, in FIGS. 25 and 26.

The ends of the sleeve 40 are juxtaposed with the inlet and output pipes at the front and back of the apparatus to inlet piping 42 and outlet piping 44 respectively. Air flow entering inlet pipe 42 travels along the sleeve containing the light fixtures and exits from outlet pipe 42 moving heat with it. The light fixtures will heat up during use and the air flow across and around the light fixtures within the glass tube or sleeve cools the light fixture or lamps by removing excess heat from the unit. The heat therefore does not build up in the sleeve, tube, drum, or in the apparatus as a whole and temperatures in the areas of the growing plants is better controlled.

The sleeve must be designed to permit light to exit from the sleeve and reach the growing plants. In the illustrated embodiment the drum is substantially in the shape of a right circular cylinder. The plants are positioned in growing trays mounted all along the periphery of a barrel of the drum. The drum rotates around the light fixture(s) in the middle of the drum positioned within sleeve 40 substantially along the centre line of the cylindrical drum 12. The sleeve allows the light from the lamps contained within to escape either by transparency or translucency.

At the front of the apparatus access is provided through inlet piping 42 thereby permitting replacement of light bulbs and light fixtures for routine maintenance through the front of the rotary gardening apparatus. Routine maintenance of the rotary garden device is therefore possible all through the front of the apparatus.

As illustrated in FIGS. 1 and 2 the front of the cylindrical drum 12 is positioned in the apparatus to face to the front of the apparatus. Some structural frame components are present on the front of the apparatus but these do not prevent the growing trays from being placed in and out of the apparatus from the front access region. All daily use of the device is from the front of the unit in a preferred embodiment. Accordingly, the unit may be placed closely beside another unit either back to back or side by side, or both. Similarly, the units may be lined up side by side with the backs of the units against a wall and space to access the unit does not need to be left between the units unlike some prior art devices in which the growing trays are placed in and out of the side.

In a preferred embodiment the drum component 12 does not have an exterior surface. It has a front metal ring 14a and a back metal ring 14b connected by a plurality of mounting support strut bars on which growing trays may be mounted. In a preferred embodiment the growing trays slide along a t-shaped protuberance extending from the strut which is an integral part of the strut. The struts are secured to the metal rings 14a and 14b.

In one embodiment the front metal ring 14a and the back metal ring 14b are made of cast aluminum, the mounting bars (struts) are made of extruded aluminum, and the growing trays are made of a suitable plastic.

In another embodiment, not illustrated, the peripheral surface of the cylindrical rotating drum component may be solid with the trays sliding directly on to the drum. A solid drum may or may not be open to the light depending on whether it allows light through the drum surface.

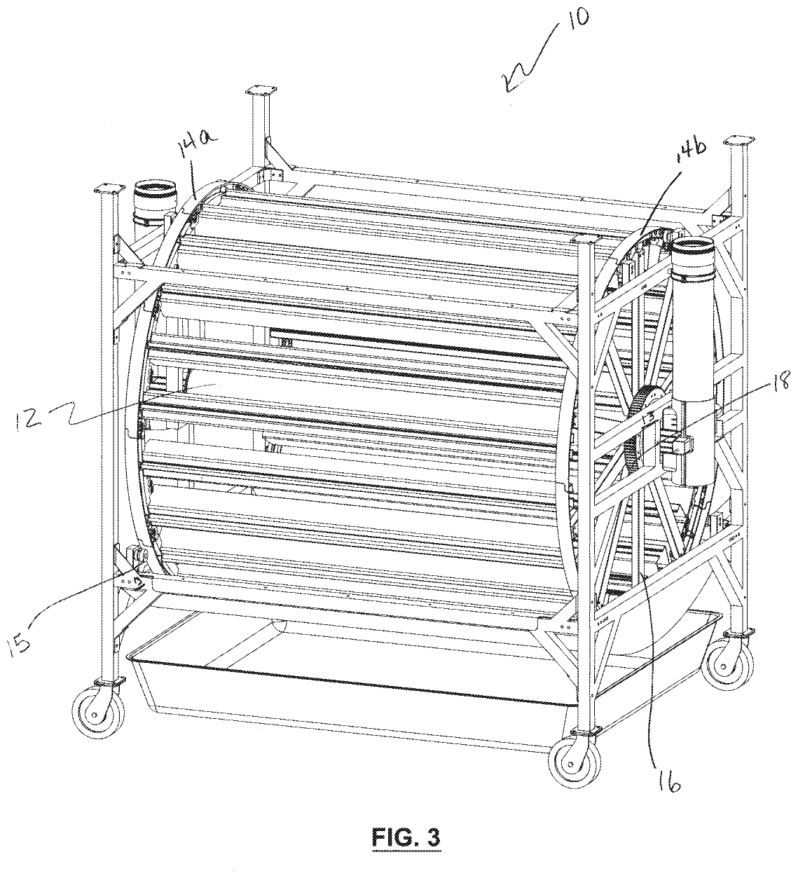

As illustrated in FIG. 3 a rear and side perspective view of one embodiment of the rotary garden growing apparatus which illustrates features of the rotary garden growing apparatus 10 at the rear of the drum and apparatus. A main gear 18 serves as a hub to rotate the drum and it is centrally located between the rear frame of the apparatus and the rear of the drum. A plurality of radially extending arms 16 extend across the rear of the drum 12 connecting to the metal ring 14b at the rear of the drum 12. These are drum support radial arms 16 which provide strength and can be in various numbers depending on the size and weight of the drum. A range of 5 to 20 radial arms is contemplated in preferred embodiments. As the main gear turns the drum 12 turns. Main gear 18 is mounted at the rear of the apparatus on the structural framework and is controlled by a control panel located at the front of the apparatus. An example of a control panel location is illustrated for example in FIG. 22 or 23.

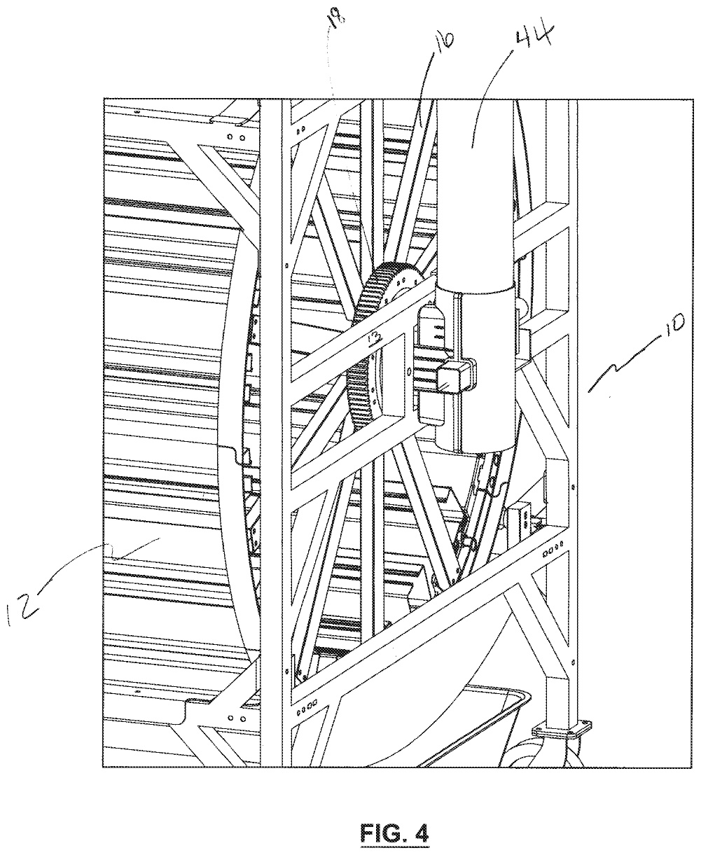

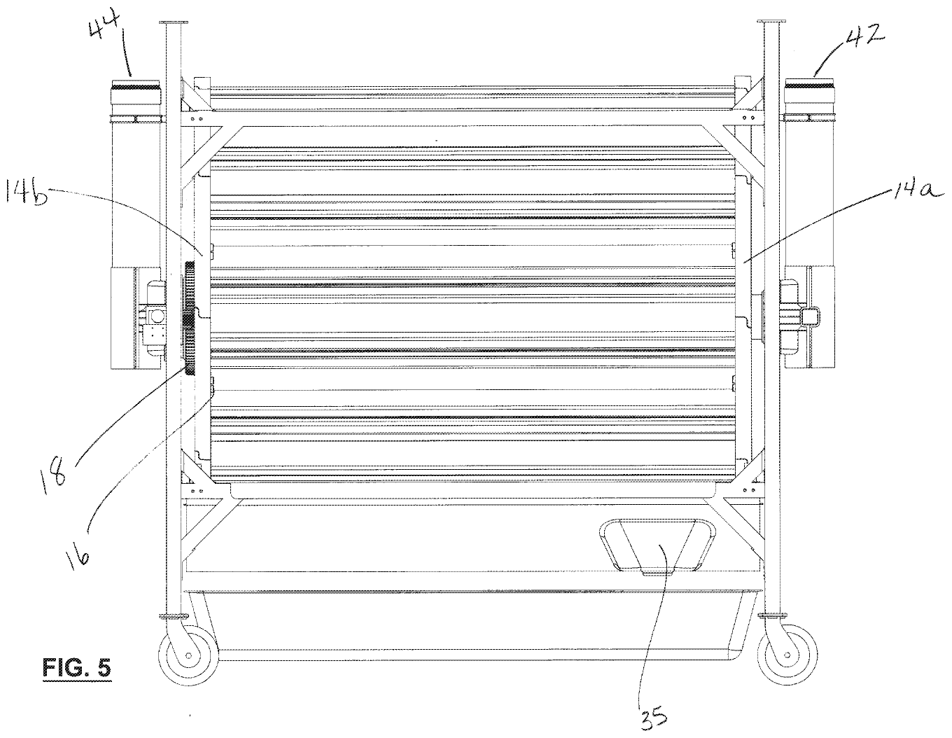

FIG. 4 illustrates a close-up view of the main gear 18 illustrating its position mounted between a plurality of radial arms 16 attached to the rear of drum 12 and the structural framework 13 of the apparatus 10. The positioning of the main gear 18 between the back of the drum 12 and structural framework of the apparatus is clearly illustrated in FIG. 5. Not shown in FIG. 5 is the mounting of main gear 18 on the structural framework and its connection to radially extending arms 16.

Drum 12 is mounted so it rests on moveable wheels 15 which support the drum frame when the drum rotates. In one embodiment there is a small wheel 15 mounted at each of four lower corners of the rotary gardening apparatus. The circular metal support rings 14a and 14b are located at each end of the drum 12 and rest on wheels 15 located at four corners of the lower portion of the structural frame 13 of the rotary garden apparatus and providing the surface on which the drum rotates on the wheels. Circular metal ring 14a located at the front of the apparatus 10 and rests on two of the wheels located on either side at the lower front the structural frame of the apparatus in the illustrated embodiment. Similarly, the metal ring 14b located at the back of the apparatus rests on the other two wheels at the lower rear of the apparatus. The positioning of the metal rings 14a and 14b on the wheels 15 is also shown in FIG. 2. The metal rings provide attachment points for the plurality of metal mounting struts which extend between them. When the struts and rings are secured together a drum is formed.

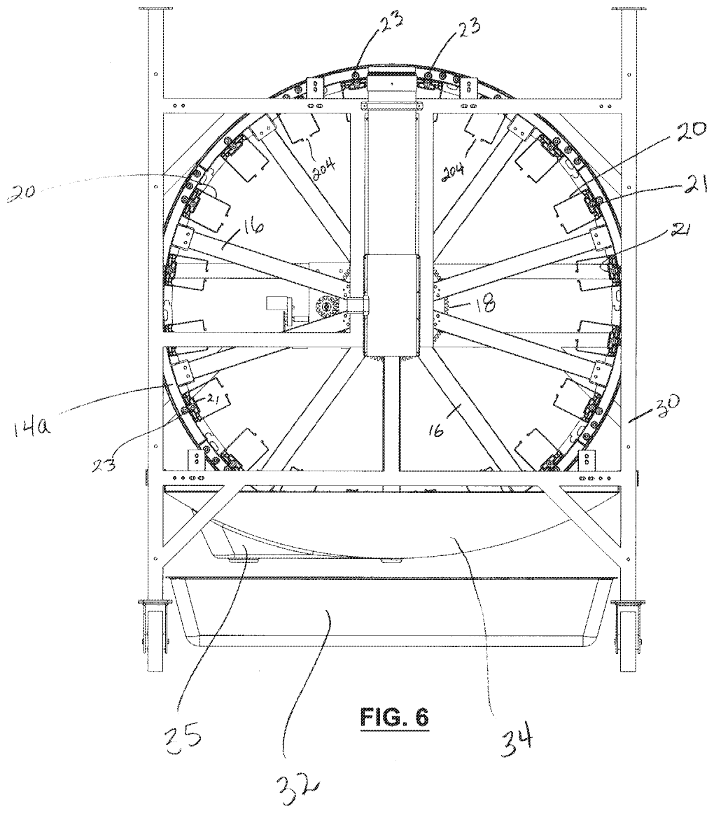

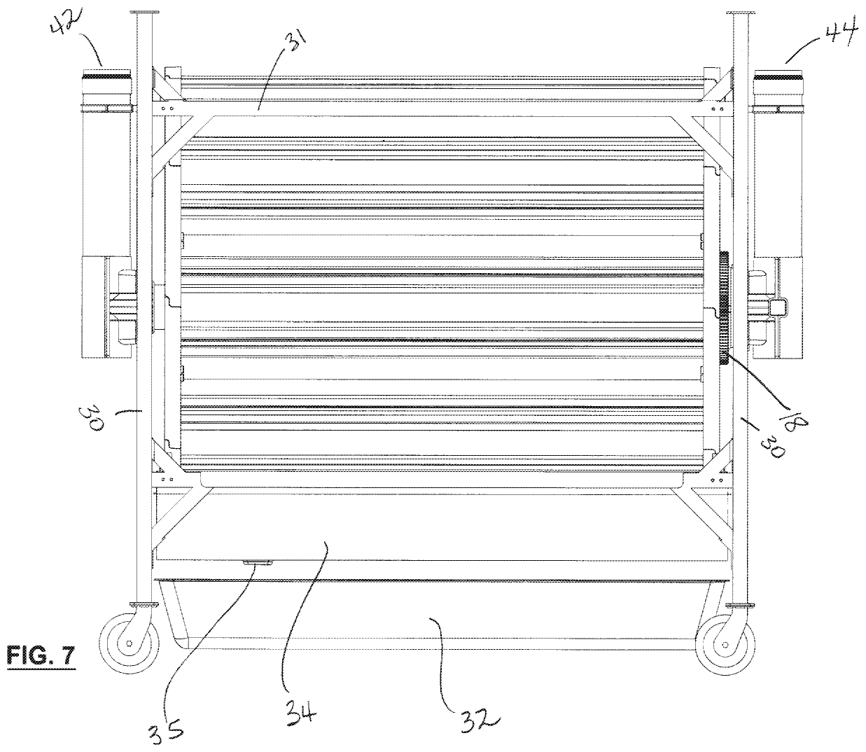

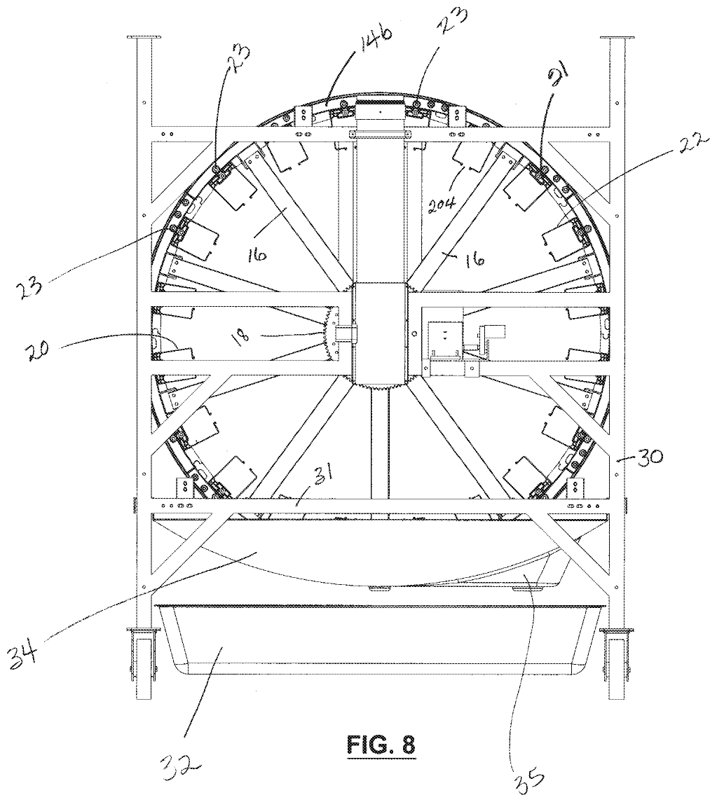

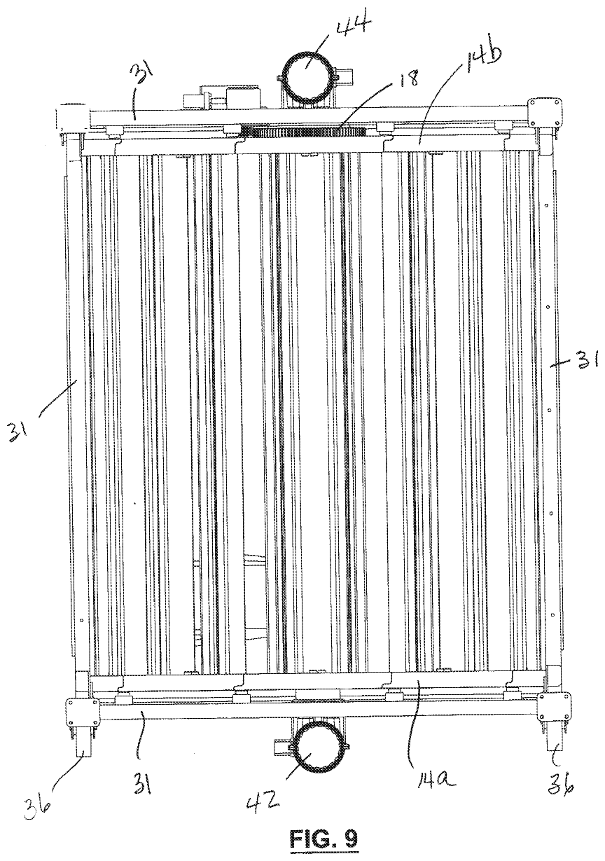

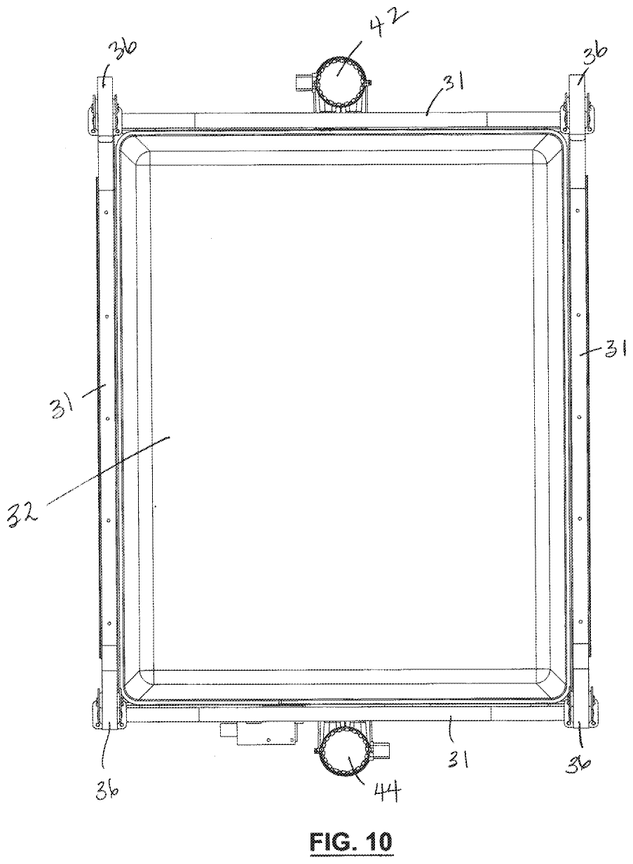

FIG. 6 illustrates a front elevation view of the apparatus and FIG. 8 illustrates a rear elevation view. In these Figures the placement of the upper feed tray 34 and lower reservoir 32 respectively in this embodiment is illustrated. Drain 35 is illustrated at the bottom of feed tray 34 showing its position for draining into lower reservoir 32 set beneath the apparatus in the illustrated embodiment.

Also illustrated in FIG. 6 is a front view of the rotary garden apparatus and FIG. 8 a rear view of the apparatus. Both views illustrate a plurality of growing trays 20 in position around the periphery of the drum. Rear metal ring 14b is illustrated and the bolts 23 indicate where the mounting struts are connected to the metal ring 14b at spaced apart intervals around the perimeter of metal ring 14b. Similarly bolts 23 are seen in FIG. 6, the front view, at spaced apart intervals on front metal ring 14a. The bolts 23 are directly above the growing trays 20 as the growing trays are illustrated in FIGS. 6 and 8. In FIGS. 6 and 8 a full set of twenty trays is illustrated in position.

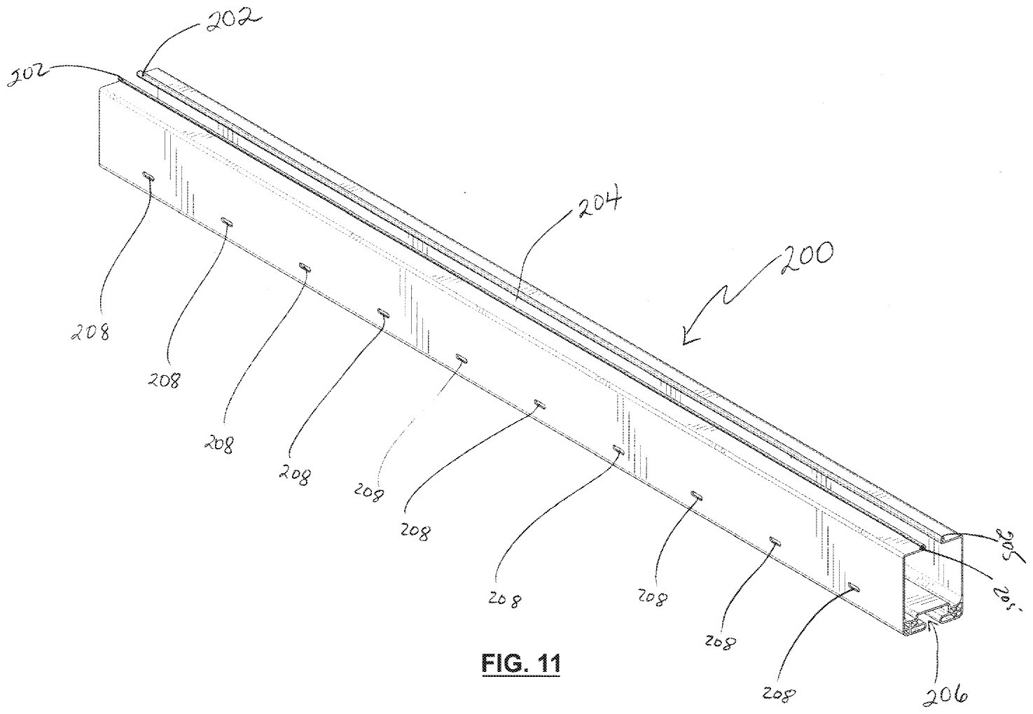

T-shaped protuberances 21 extending from a mounting support strut metal bar are also illustrated in FIGS. 6 and 8. Each T shaped protuberance 21 has a growing tray 20 slidably mounted over the protuberance 21 by a matching opening along the bottom of tray 20. The reciprocal opening on a growing tray which matches the protuberance 21 shape is seen for example in FIG. 11 at number 206.

The trays 20 are illustrated with opening 204 in the top of growing trays 20 is illustrated without a gasket or other cover in place on the tray. The openings 204 located on the top of growing trays 20 point towards the centre of the drum component of the apparatus where one or more light fixtures may be located. The twenty growing trays are illustrated fully or partially in FIGS. 6 and 8.

Also illustrated in FIGS. 6 and 8 some growing trays 20 will be positioned within the feed tray at any time. The reservoir may have a solution in the feed tray when the plants are being watered and nourished, or it may be empty.

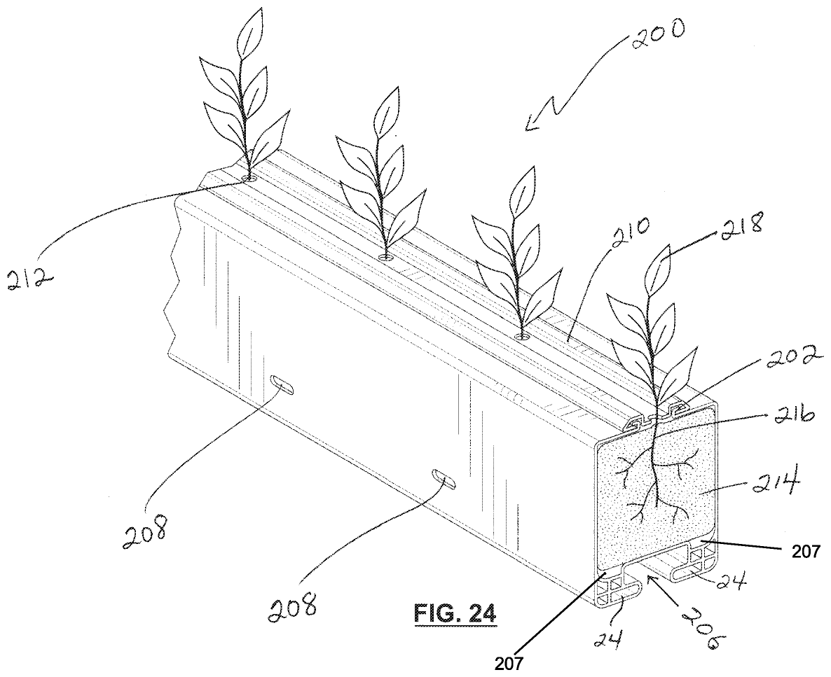

When the feed tray is filled with a nutrient solution the growing trays and the plants and rockwool cubes contained within the growing trays will pass through the nutrient solution and absorb some of the solution which is retained by the rockwool cube hydroponic substrate. The plants and hydroponic substrate are not illustrated in. FIG. 6. The positioning and placement in one embodiment of a plant 218 and its roots 216 in a rockwool cube 214 in a close-up view of a growing tray 200 is illustrated in FIG. 24. Also visible in FIG. 24 is the reciprocal opening 206 that matches the shape of the T shaped protuberance 21 projecting from a strut bar 22. In FIG. 24 below the rockwool cube 214 is a channel or space 207. These channels or spaces 207 are on either side of the “cross of the T” of the reciprocal opening 206. These channels or spaces 207 form around the substrate such as the rockwool cube 214 illustrated as one embodiment in the Figures. The substrate does not entirely fill the tray so water and nutrient solutions can circulate around the substrates and be absorbed or released to better management the moisture management of the substrates. Excess moisture not absorbed into the substrate such as the rockwool cube can reside in these locations such as 207.

The plants in the growing trays will grow towards a light located in the central region of the apparatus and the light is surrounded by the growing plants which are mounted in a growing tray which is mounted in position along the periphery of the drum. As the plants grow they emerge from the opening slit along the top of the growing tray and mature.

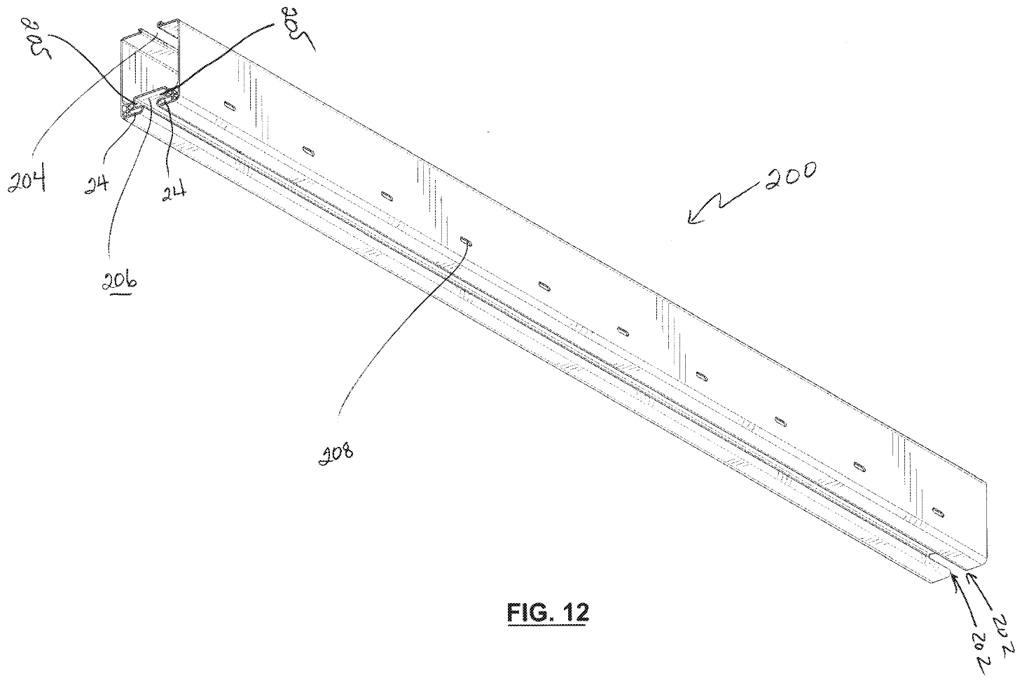

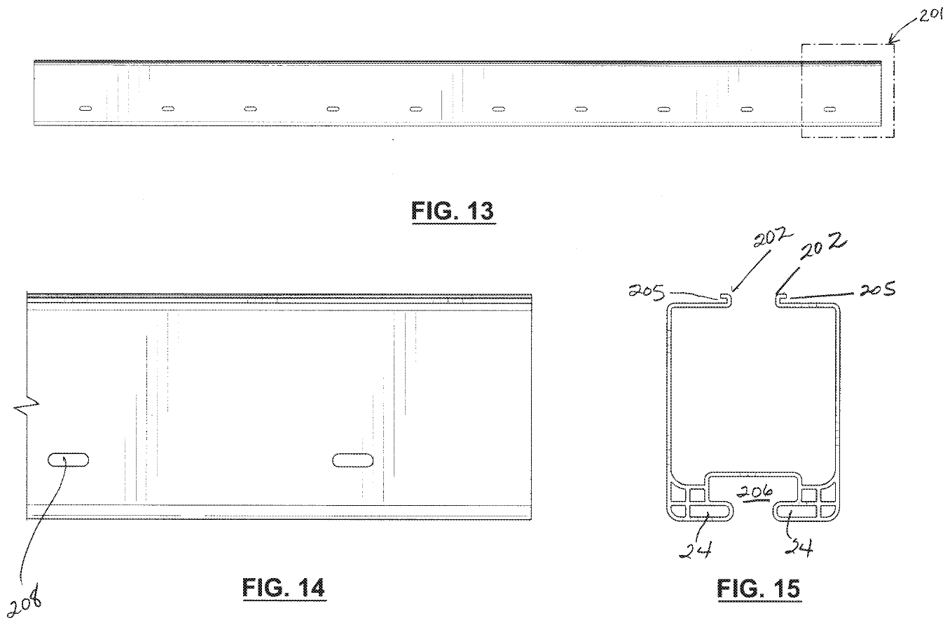

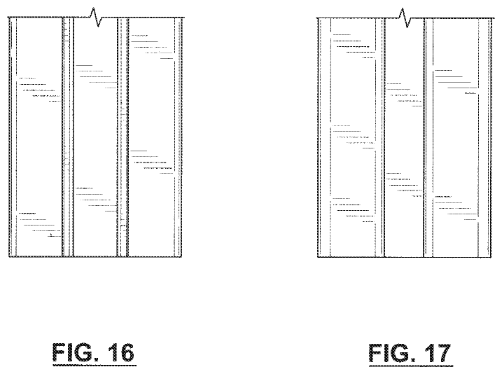

In FIGS. 11 to 14 an embodiment of a growing tray 200 is illustrated. An opening slot 204 is present in the top of tray 200 through which a plant can grow. The opening slot 204 is defined by the edges 202 of the growing tray which further comprise a lip 205 over which a cover (not illustrated) may be mounted. A plurality of side openings 208 are illustrated in this preferred embodiment which permit water and nutrients to readily access the roots of the growing plants in the hydroponic substrate and to drain from the substrate. In one preferred embodiment the side openings range from 1.8 to 2.8 cm in elongate width. In FIG. 24 the openings 208 do not reveal any visible substrate in the Figure; however, in other embodiments the substrate may be observed through the openings 208 depending on the type of substrate used and its location relative to the opening 208. In a further preferred embodiment, the openings 208 line up with a rockwool cube substrate where the plant is located. While preferred, it is not required.

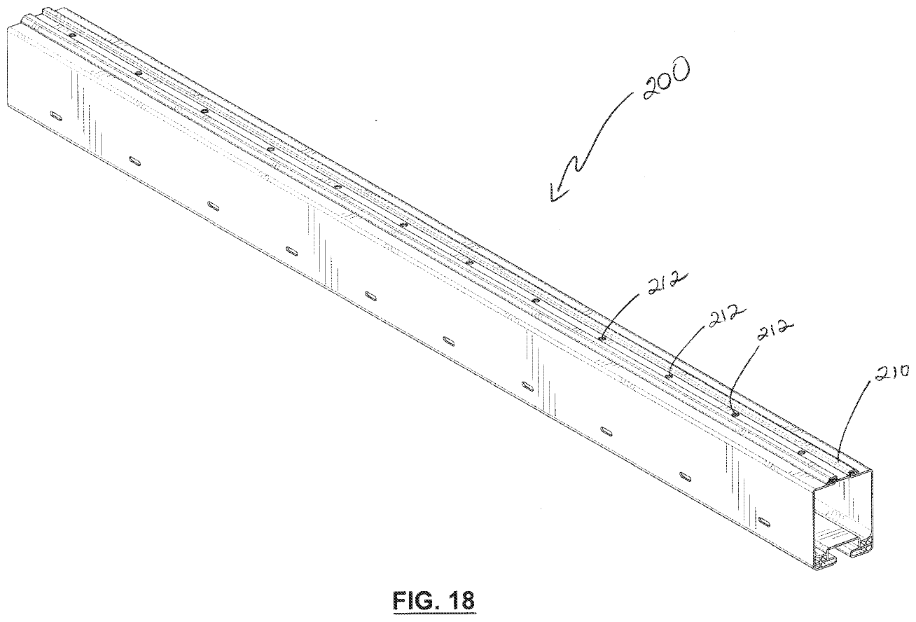

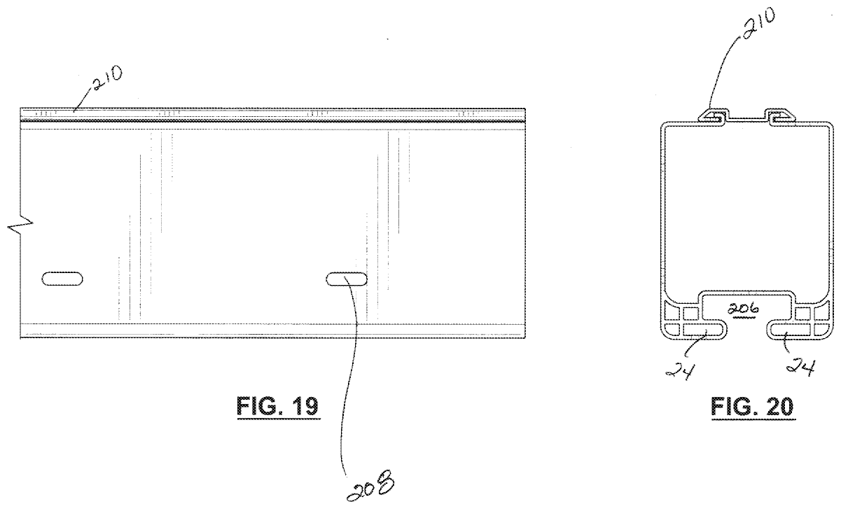

In FIGS. 18 to 20 growing tray 200 is illustrated with a cover 210 present over the top opening slot of the grow tray. In a preferred embodiment, as illustrated, the cover 210 is a gasket of flexible, water-impermeable material which covers the opening securely stretching into position by latching over edges 202 and beneath lip 205 thereby attaching over top of the opening slot 204.

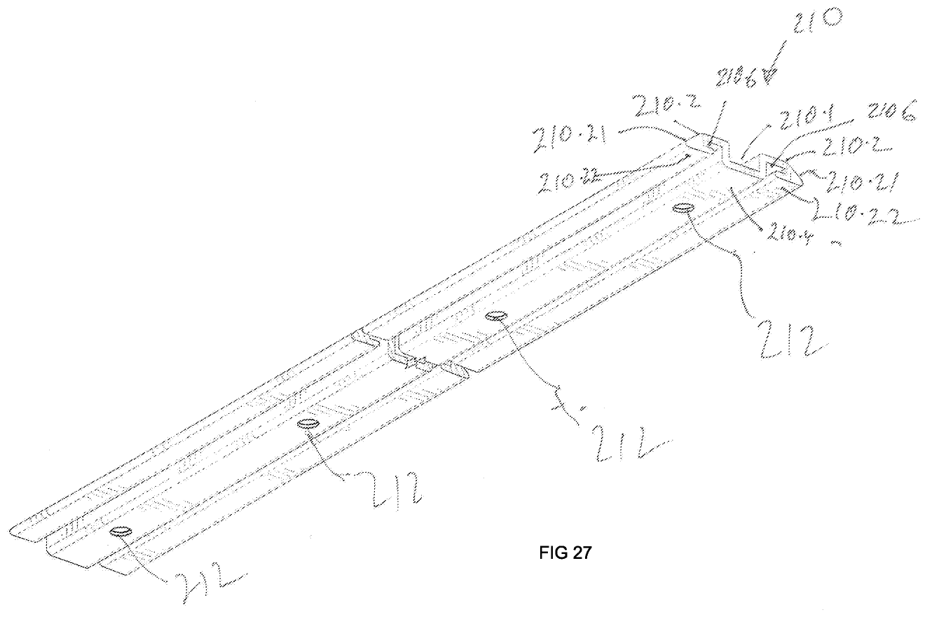

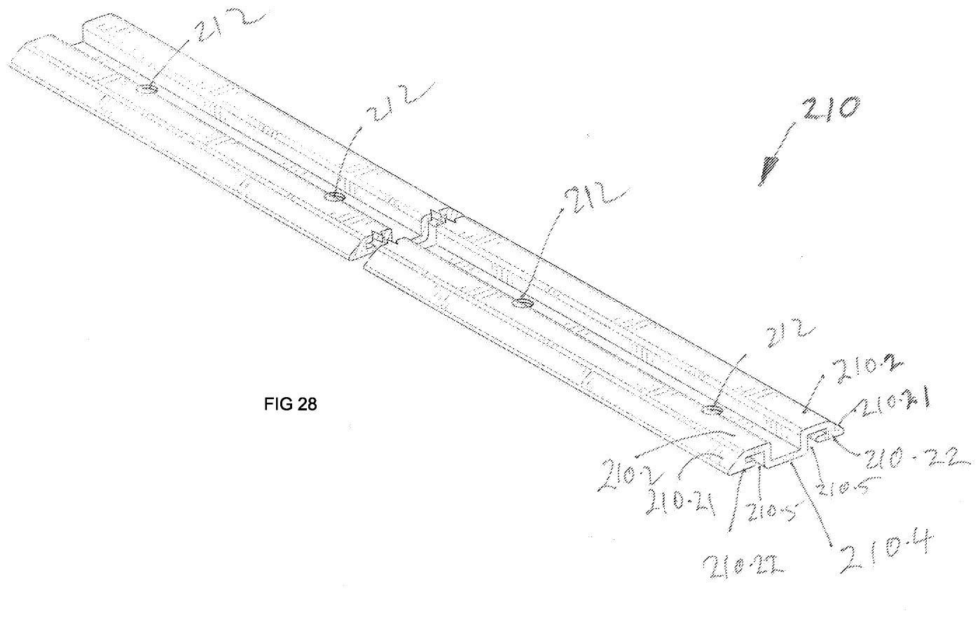

As illustrated in FIGS. 27 and 28, the cover 210 is of a linear construction in the nature of a linear strip including on one side, a central channel or trough 210.1. Running parallel on either side of the channel trough 210.1 are two side portions 210.2. The channel trough 210.1 and side portions 210.2 extend in parallel substantially along the entire length of the linear tray cover 210. The side portions 210.2 run in parallel with a central channel trough 210.1 which is formed between the two side portions 210.2 along the entire length of the linear tray cover 210. The channel trough 210.1 further comprises a plurality of openings 212, in this case circular apertures, arranged linearly along its length. The outside edges 210.21 of each side portion are beveled from the top of the cover to the base of the cover 210, so that the base of the cover 210 is wider than the tip. In a longitudinal section along the centre midway axis of the linear tray cover 210 the resultant section portions are substantially mirror images. In cross section along any transverse section of the linear tray cover 210 the shape of the cross section comprises opposite hook-shaped portions 210.22 separated by a flat-based U shape 210.4. The hook-shaped portions 210.22 are formed from the base of the side portions 210.2 and extend towards the center of the cover 210, and terminate so that a space 210.5 is formed with the outboard side wall of the central channel trough 210.1. The hook shaped portions 210.22 also are spaced from the under surface of the side portions by a space 210.6.

FIG. 21 depicts an enlarged view of a growing tray 200. Adjacent to growing tray 200 are two other growing trays 200′ (in part to the right) and 200″ (to the left) illustrated in the embodiment shown in FIG. 21. In dotted lines the T-shaped protuberance 21 is illustrated. This illustrates only a portion of the protuberance which extends along the full length of the mounting strut over which the growing tray slides. Either individual protuberance may drop down from the metal strut over which the grow tray is mounted. Opening 206 is reciprocally shaped to the protuberance 21 and slides along where it is held in place by the overhang portions 24 of the growing tray. A directional arrow is shown representing that the growing tray moves in and out along that direction line as it slides in and out of position on the mounting strut.

FIG. 21 does not depict the hydroponic substrate or the plant in position however when the growing tray is inserted in and out of the apparatus it will normally contain hydroponic substrate and plants. The growing plants grow through the opening slot and generally do not interfere with the movement of the growing tray in and out of the apparatus. Not illustrated in FIG. 21 are side openings in growing tray 200. In a preferred embodiment, small side openings may be present as illustrated in other figures as reference number 208.

FIG. 22 is another perspective view of the apparatus illustrating a side and front view of the apparatus. In this view a control box 60 is shown mounted on the front of the apparatus in dot-chain. The control box 60 is mounted on the structural frame of the apparatus to the left of the ventilation piping 42 and 44 in this embodiment leaving an open access to the interior of the drum to the right of the piping 42 and 44. This can also be seen in the stacked configuration illustrated in FIG. 23.

The mounting struts 22 which extend from metal wheel 14b to metal wheel 14a are seen in this view with a growing tray 20 mounted in strut 22. The connection point between a strut 22 and the metal ring 14b is visible at 25 for example.

Representational ventilation fans are depicted in dot-chain in FIGS. 22 and 23 at the front 62 and rear 64 of the apparatus. Ventilation may be housed in the ceiling of a room as part of a centralized ventilation system or individual fans may be used on single units of apparatus. When the apparatus is stacked the ventilation pipes 44 and 42 can be extended to reach both the top and the bottom unit.

When stacked, feet 70 and 72 will abut as illustrated at reference number 75. The feet can be secured together using screws at holes 71.

As seen for example in FIGS. 22 and 23 when facing the front of the unit there is an open area to the right of the piping 42 and 44. The control box 60 is to the left of the piping and the open access region is to the right of the piping. The Control box can serve as a power supply. In one embodiment a power cord connects to the power supply in the front control box 60. In another specific embodiment it uses one 120V 15 amp plug and a 208-277V 15 amp plug.

In one embodiment there is a control panel present on or within the control box 60 (not illustrated) which is covered by a door to protect the parts. The control panel on the control box controls the rotational speed of the apparatus through present or programmed settings. In one embodiment the rate of rotation is selected using one of three buttons for different rates. In one embodiment the different rotational rates which can be selected are one rotation per hour, one rotation per 20 minutes and one rotation per 5 minutes.

All of the growing trays can be inserted and removed from the unit through the access opening at the front of the unit. As the drum is rotated the trays are accessible through this access opening into the central portion of the drum in the apparatus. In use, a growing tray 20 comprises an opening with an overhang which reciprocally matches a protuberance 21 on a mounting strut 22. In one embodiment the growing tray is substantially the same length as the drum, or slightly shorter in length. As the growing tray slides along the T shaped protuberance 21 extending from the mounting strut the tray 20 is inserted into the drum. The tray comprises a reciprocal opening groove along its base which is fitted to slide along the protuberance. The protuberance extends from the strut in an inverted T shape and the base of the tray slides along it. The base of the tray has openings to match the arms on the inverted T shaped protuberance and this holds it in place. The tray fits snuggly but slides readily and stays in place during rotation without further clips or devices. No additional pins or other mechanisms are need to hold the tray in place.

So that the tray does not extend past the end of the drum there is an abutment mounted at the rear end of the metal strut which the tray will bump against when it is inserted and will not proceed further. It is effectively a means to stop the tray from loading further along the strut. The abutment may be permanent and integral part of the strut or it could be removable and repositioned to accommodate trays of different lengths within the apparatus. In one embodiment the abutment is a round piece of aluminum which extends down from the strut at the rear of the strut. It may be fitted around the T-portion protrusion or it may be located at the end of the T-shaped protuberance extending down from the metal strut. It is positioned securely in place. It may be an aluminum piece that is attached to the strut by a bolt, in a preferred embodiment.

In FIG. 23 there are two units of the apparatus illustrated in a stacked position. As illustrated in FIG. 23 the bottom unit retains wheels 36 but it does not have to have the wheels. In this embodiment the apparatus has feet at the four corners on the bottom and at the top of the vertical supports 30. The feet can be in any shape. In this embodiment they are flat platforms which permit at least one unit to be stacked on top of a second unit. The rotary garden growing apparatus is suited to this arrangement as users routinely can operate the unit from the front of the apparatus.

FIGS. 25 and 26 illustrate positioning of light bulbs in the light fixture/source located in about the middle of the drum and apparatus. Bulbs 39 are lined up in the sleeve 40. In this embodiment the light fixture 40 is positioned centrally in front of the main gear 18. Radial support arms 16 are visible. In FIG. 26 another embodiment of the apparatus with only 5 radial support arms 16′ is seen. A plurality of radial support arms may be present between the metal ring 14b and a central hub. In a preferred embodiment the number of support arms is 5.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

While the above detailed description has shown, described and identified several novel features of the invention as applied to one or more preferred embodiments, it will be understood that various omissions, substitutions and changes in the form and details of the described and/or illustrated embodiments may be made by those skilled in the art without departing from the spirit of the invention which is defined by the appended claims.

What is claimed is:

1. A rotary garden apparatus for growing plants comprising an open rotatable drum mounted within a structural frame said apparatus comprising an apparatus front end and an apparatus back end,
said drum comprising two drum support rings between which a plurality of mounting struts are extended and connected to each drum support ring;
said drum further comprising radial support arms attached at a back end of said apparatus extending across a diameter of said drum support ring at said drum back end;
said mounting struts comprising a protuberance said protuberance comprising arm portions and said protuberance extending along said mounting strut;
said drum further comprising a substantially open drum front end;
said substantially open drum front end further comprising an accessible area through said opening is unobstructed by said structural frame;
said apparatus further comprising a main gear mounted to said apparatus back end;
said apparatus further comprising a feed tray mounted to said structural framework and positioned below said drum;
said apparatus further comprising a lower reservoir positioned below said feed tray and said lower reservoir is optionally connected to said frame;
wherein said drum rotates within said structural framework passing through said feed tray.

2. The rotary garden apparatus according to claim 1 wherein said drum is rotatably mounted in said structural framework on moving wheels within said framework.

3. The rotary garden apparatus according to claim 2 further comprising removable grow trays.

4. The rotary garden apparatus according to claim 3 wherein said grow trays are slidably mounted on said mounting struts.

5. The rotary garden apparatus according to claim 4 wherein said trays are substantially the same length as said mounting struts.

6. The rotary garden apparatus according to claim 5 wherein said trays comprise a central groove said groove being reciprocally shaped to receive the protuberance or be received by the protuberance as said tray slides into position on said mounting strut.

7. The rotary garden apparatus according claim 6 wherein said protuberance is substantially an inverted T shape and said groove fits over said protuberance engaging the two together.

8. The rotary garden apparatus according to claim 7 wherein said trays are slidably inserted from said apparatus front end.

9. The rotary garden apparatus according to claim 8 wherein said trays are substantially square or rectangular in cross section.

10. The rotary garden apparatus according to claim 9 wherein said groove is on a bottom side of said tray and an opening slot is present along the top of said tray and said opening slot points towards the inside of said drum when mounted on said mounting strut.

11. The rotary garden apparatus according to claim 10 wherein said tray further comprises a cover over said slot.

12. The rotary garden apparatus according to claim 11 wherein said cover is a gasket and said gasket further comprises at least one opening which aligns with said opening slot.

13. The rotary garden apparatus according to claim 12 wherein said gasket is impermeable to water and stretchably fits over said slot on said tray.

14. The rotary garden apparatus according to claim 13 wherein said tray further comprises at least one opening on at least one side of said tray.

15. The rotary garden apparatus according to claim 14 wherein said at least one opening is from about 1.8 cm to about 2.8 cm in width.

16. The rotary garden apparatus according to claim 1 wherein said apparatus further comprises a light fixture suitable for growing plants.

17. The rotary garden apparatus according to claim 16 wherein said light fixture is centrally located in the interior of said drum.

18. The rotary garden apparatus according to claim 17 wherein said light fixture is contained within a translucent or transparent sleeve.

19. The rotary garden apparatus according to claim 18 wherein said light fixture is accessible from the apparatus front end.

20. The rotary garden apparatus according to claim 19 wherein said apparatus further comprises ventilation means to disperse heat generated from said light fixture.

21. The rotary garden apparatus according to claim 20 wherein said ventilation means further comprises ventilation input and output pipes located at said apparatus front end and said apparatus rear end respectively.

22. The rotary garden apparatus according to claim 21 where said ventilation piping is connected to said sleeve and air is transferred through said input piping through said sleeve and out said output piping.

23. A rotary garden apparatus according to claim 1 wherein said drum support rings are made of metal and said mounting struts are made of metal.

24. A removable growing tray for a rotary garden apparatus, said tray being shaped so as to be slidably receivable by supports or struts of a rotary garden apparatus and supported during rotation of said rotary garden apparatus.

25. The removable growing tray as claimed in claim 24 wherein said trays are substantially the same length as said supports or struts of the rotary garden apparatus.

26. The removable growing tray as claimed in claim 25 wherein said trays comprise at least one groove shaped to receive and to cooperate with a protuberance on said supports or struts of said rotary garden apparatus to allow the two to engage together, or slidably engage together.

27. The removable growing tray as claimed in claim 26 wherein said at least one groove has a T-shape.

28. The removable growing tray as claimed in claim 27, wherein said groove is on a one side of said tray and an open slot is present along an opposite side of said tray and said open slot is adapted to be directed towards the inside of a rotary garden apparatus when mounted thereon.

29. The removable growing tray as claimed in claim 28, wherein said tray further comprises at least one cover or gasket to partially or wholly close said open slot.

30. A removable growing tray according to claim 29 wherein a hydroponic substrate is present inside said tray.

31. A removable growing tray as claimed in claim 29, wherein plants are present in said tray in a hydroponic substrate.

32. A removable growing tray as claimed in claim 31 wherein said plants grow through said open slot and through said at least one opening in said cover or gasket.

33. A growing tray cover for closing an opening of a growing tray, said cover having a central portion, and at least one side portion which is adapted to engage at least one formation on a growing tray so that said cover and said tray can be assembled together.

34. A growing tray cover as claimed in claim 33, wherein said cover includes two side portions.

35. A growing tray cover as claimed in claim 34, wherein said at least one side portion includes a beveled portion.

36. A growing tray cover as claimed in claim 35, wherein said central portion includes at least one aperture therethrough to allow a plant to grow through.

37. A growing tray cover as claimed in claim 36, wherein said central portion includes a channel section.

38. A growing tray cover as claimed in claim 37, wherein said channel section includes said at least one aperture.
